(19) United States
(12) Patent Application Publication
(10) Pub. No.: US 2025/0262764 A1
(43) Pub. Date: Aug. 21, 2025

(54) STATUS PROMPT METHOD, PICKING ROBOT, AND STORAGE MEDIUM

(71) Applicant: Beijing Youzhuju Network Technology Co., Ltd., Beijing (CN)

(72) Inventors: Linge ZHANG, Beijing (CN); Yin YIN, Beijing (CN)

(21) Appl. No.: 19/033,457

(22) Filed: Jan. 21, 2025

(30) Foreign Application Priority Data
Feb. 18, 2024 (CN) 202410181993.0

(51) Int. Cl. B25J 9/16; G06Q 10/087

(52) U.S. Cl. CPC B25J 9/1661; B25J 9/1653; G06Q 10/087

(57) ABSTRACT

Embodiments of the present disclosure provide a status prompt method, a picking robot, and a storage medium. The method includes: obtaining task execution information of a picking robot during execution of a picking task by the picking robot, the picking robot moves between a plurality of shelves in a warehouse to transport items, and the shelf includes a plurality of goods storage compartments for separate storage of different items; determining, based on the task execution information and from a plurality of preset task execution stages corresponding to the picking task, a target task execution stage at which the picking robot stays, and determining, based on the target task execution stage, status prompt information corresponding to the picking robot; and presenting the status prompt information based on an information prompt device provided on the picking robot.

### CROSS-REFERENCE TO RELATED APPLICATION(S)

The present disclosure claims priority of Chinese Patent Application No. 202410181993.0 filed on Feb. 18, 2024, the disclosure of which is incorporated herein by reference in its entirety as part of the present application.

### TECHNICAL FIELD

Embodiments of the present disclosure relate to computer application technologies, and in particular, to a status prompt method, a picking robot, and a storage medium.

### BACKGROUND

In warehousing scenarios, because a large variety and number of items are stored in a warehouse, they are usually preplanned for their placement positions in the warehouse to facilitate picking. In some scenarios, a plurality of picking robots cooperate with a picker to perform picking tasks in the warehouse, in order to improve picking efficiency. In such scenarios, whether the picking robots cooperate with the picker smoothly is one of the important factors affecting the picking efficiency.

In the related art, the picker determines a task execution status of the picking robot by manually observing the movement, pause, position, and other information of the picking robot, and then determines cooperation between the picker and the picking robot. Such a human-computer interaction mode mostly relies on the picker's experience-based judgment, with relatively limited interactive information available from the picking robot, which easily leads to misoperation or delayed operation, thus affecting the efficiency in executing the picking tasks.

### SUMMARY

The present disclosure provides a status prompt method and apparatus, a picking robot, a storage medium, and a program product, to enrich presentations of interactive information by a picking robot.

According to a first aspect, an embodiment of the present disclosure provides a status prompt method. The method includes:
obtaining task execution information of a picking robot, and determining, based on the task execution information, a target task execution stage at which the picking robot stays, where the picking robot moves between a plurality of shelves in a warehouse to transport items, and the shelf includes a plurality of goods storage compartments for separate storage of different items;
determining, based on the target task execution stage, status prompt information corresponding to the picking robot, where the target task execution stage includes at least a picking stage and an item review stage; and
presenting the status prompt information based on an information prompt device provided on the picking robot.

According to a second aspect, an embodiment of the present disclosure further provides a status prompt apparatus. The apparatus includes:
a target task execution stage determination module configured to obtain task execution information of a picking robot, and determine, based on the task execution information, a target task execution stage at which the picking robot stays, where the picking robot moves between a plurality of shelves in a warehouse to transport items, and the shelf includes a plurality of goods storage compartments for separate storage of different items;
a status prompt information determination module configured to determine, based on the target task execution stage, status prompt information corresponding to the picking robot, where the target task execution stage includes at least a picking stage and an item review stage; and
a status prompt information display module configured to present the status prompt information based on an information prompt device provided on the picking robot.

According to a third aspect, an embodiment of the present disclosure further provides an electronic device. The electronic device includes:
one or more processors; and
a storage apparatus configured to store one or more programs,
where the one or more programs, when executed by the one or more processors, cause the one or more processors to implement the status prompt method according to any one of the embodiments of the present disclosure.

According to a fourth aspect, an embodiment of the present disclosure further provides a storage medium containing computer-executable instructions, where the computer-executable instructions, when executed by a computer processor, are used to perform the status prompt method according to any one of the embodiments of the present disclosure.

According to a fifth aspect, an embodiment of the present disclosure further provides a computer program product including a computer program that, when executed by a processor, implements the status prompt method according to any one of the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a status prompt method according to an embodiment of the present disclosure;

FIG. 2 is a schematic flowchart of another status prompt method according to an embodiment of the present disclosure;

FIG. 3 is a schematic flowchart of still another status prompt method according to an embodiment of the present disclosure;

FIG. 4 is a schematic diagram of a structure of a status prompt apparatus according to an embodiment of the present disclosure; and

FIG. 5 is a schematic diagram of a structure of an electronic device according to an embodiment of the present disclosure

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

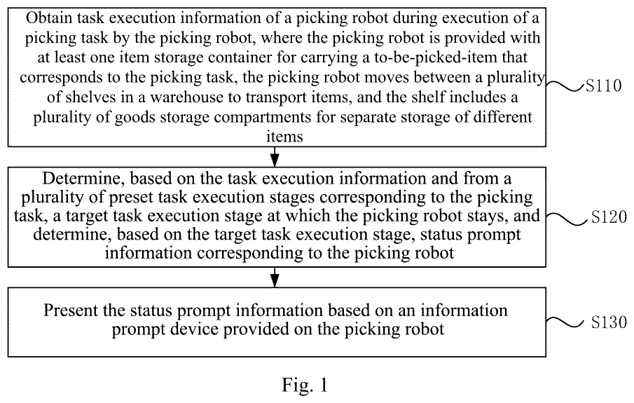

FIG. 1 is a schematic flowchart of a status prompt method according to an embodiment of the present disclosure. This embodiment of the present disclosure is applicable to a case where display of status prompt information is added to a picking robot in a warehouse. The method may be performed by a status prompt apparatus, which may be implemented in the form of software and/or hardware, and optionally, by an electronic device provided on or integrated into a picking robot. The electronic device may be an external control terminal or a robot control processing chip, etc.

As shown in FIG. 1, the method in this embodiment may specifically include the following steps.

S110: Obtain task execution information of a picking robot during execution of a picking task by the picking robot, where the picking robot is provided with at least one item storage container for carrying a to-be-picked-item that corresponds to the picking task, the picking robot moves between a plurality of shelves in a warehouse to transport items, and the shelf includes a plurality of goods storage compartments for separate storage of different items.

The picking task may be understood as a process of obtaining, according to requirements of one or more picking orders, an item corresponding to the picking order from a shelf in the warehouse, placing the item into a designated item storage container, and transporting the item to a target position. The task execution information may be understood as information that is presented by the picking robot during the execution of the task. For example, the task execution information may include, but is not limited to, at least one of task setting information (such as at least one of a task identifier, a task start time, a task end time, a task type, and a task target position) of the picking robot, a moving status of the picking robot, a real-time position of the picking robot in the warehouse, etc.

Optionally, the obtaining task execution information of a picking robot may be obtaining task execution data of the picking robot based on a preset task execution parameter, and then using the task execution parameter and the task execution data as the task execution information of the picking robot.

S120: Determine, based on the task execution information and from a plurality of preset task execution stages corresponding to the picking task, a target task execution stage at which the picking robot stays, and determine, based on the target task execution stage, status prompt information corresponding to the picking robot.

The preset task execution stages may be a plurality of stages obtained by dividing a plurality of operations required for completing the picking task. Exemplarily, the preset task execution stages corresponding to the picking task may include at least a picking stage and an item review stage. Status prompt information corresponding to different preset task execution stages may be generated in different ways. Exemplarily, the status prompt information corresponding to the different preset task execution stages may be generated by using different information display colors. For example, status prompt information corresponding to the picking stage may be generated by using a first color (e.g., blue); and status prompt information corresponding to the item review stage may be generated by using a second color (e.g., green).

In this embodiment of the present disclosure, the target task execution stage at which the picking robot stays may be determined by analyzing the task execution information. Specifically, the task execution information may be compared with reference execution information corresponding to each of the preset task execution stages, and the target task execution stage at which the picking robot stays may be determined based on a comparison result.

Optionally, the determining, based on the target task execution stage, status prompt information corresponding to the picking robot includes: obtaining a preset information presentation restriction parameter corresponding to the target task execution stage, and generating, based on the information presentation restriction parameter, the status prompt information corresponding to the picking robot. The information presentation restriction parameter is a display parameter used to restrict an information presentation mode of the status display information. Exemplarily, the information presentation restriction parameter may include at least one of an information presentation type, information presentation content, and an information display restriction parameter. The information display restriction parameter includes an information color restriction parameter and/or a display form restriction parameter. The display form restriction parameter includes at least one of a display shape restriction parameter, a display size restriction parameter, a display position restriction parameter, a display frequency restriction parameter, and a display time restriction parameter.

S130: Present the status prompt information based on an information prompt device provided on the picking robot.

The information prompt device may be understood as a device for information presentation. Exemplarily, the information prompt device includes at least one of a sound playback device, an indicator light, and an information display device. The information display device may be a display screen. The display screen may further support a touch operation.

Optionally, the presenting the status prompt information based on an information prompt device provided on the picking robot includes at least one of the following operations: playing, based on the sound playback device provided on the picking robot, a target sound effect corresponding to the status prompt information; determining, based on the status prompt information, light information of the indicator light provided on the picking robot, and controlling the indicator light to present the light information; and displaying the status prompt information in a preset information display form based on the information display device provided on the picking robot, where the information display form includes at least one of graphics, text, an animation, and a video. The target sound effect includes preset music and/or preset voice, etc.

In the technical solutions of the embodiments of the present disclosure, first, the task execution information of the picking robot is obtained, and the target task execution stage at which the picking robot stays is determined based on the task execution information, so that the target task execution stage at which the picking robot stays when the picking robot moves between the plurality of shelves in the warehouse to transport items can be accurately determined, to implement refined division of the target task execution stage at which the picking robot stays. Then, the status prompt information corresponding to the picking robot is determined based on the target task execution stage, so that status prompt information corresponding to different target task execution stages can be determined separately, to provide distinguished prompts for the different target task execution stages. Finally, the status prompt information is presented based on the information prompt device provided on the picking robot, where by providing the information prompt device on the picking robot, it is convenient for a user to quickly locate the picking robot that generates the status prompt information, and the status prompt information displayed on the picking robot allows a picker to learn the target task execution stage at which the picking robot stays in a timely, convenient, and intuitive manner. Thus, the technical problems of relatively limited interactive information available from picking robots and low efficiency in executing picking tasks are solved, the experience of the picker during information interaction with the picking robot is enhanced, and the task execution efficiency of the picking robot is improved.

As an optional technical solution of the embodiments of the present disclosure, the status prompt method may further include: performing detection of an associated robot based on the picking robot, generating, based on a detection result, movement guidance information corresponding to a picker, and presenting the movement guidance information, where the associated robot is a picking robot that is closest to the picking robot and whose distance from the picking robot is within a preset distance range. Such a setting has an advantage of further enabling detection of a picking robot nearby and properly guiding the movement of the picker based on the position of the picking robot nearby, thereby improving picking efficiency.

The movement guidance information may be understood as information for guiding the picker to move within the warehouse. Specifically, the movement guidance information includes first guidance information and second guidance information. In this case, the generating, based on a detection result, movement guidance information corresponding to a picker may specifically include: when the associated robot corresponding to the picking robot has been detected, generating the first guidance information for prompting the picker to move to the associated robot; or when the associated robot corresponding to the picking robot has not been detected, generating the second guidance information for prompting the picker to follow the picking robot. Because the associated robot is a picking robot that is closest to the picking robot and whose distance from the picking robot is within the preset distance range, such a setting has an advantage of directing the picker to operate the picking robot nearby, saving walking time in the warehouse, optimizing a collaboration mode between the picker and a plurality of picking robots, and improving picking efficiency.

As an optional technical solution of the embodiments of the present disclosure, the status prompt method may further include: determining target abnormality information when an abnormality is detected in the picking robot, and displaying at least one abnormality candidate item on the picking robot based on the target abnormality information; and reporting, in response to an item selection operation for the abnormality candidate item, a selected abnormality candidate item to a target management terminal. Such a setting has an advantage of determining, when an abnormality occurs in the picking robot, the target abnormality information of the picking robot in a timely manner to conduct abnormality analysis on the picking robot, presenting relevant abnormality candidate items for the user to select, and then accurately determining the abnormality item of the picking robot for reporting in conjunction with the user operation, so that the target management terminal is informed of the abnormality in the picking robot in a timely manner and records information on the abnormality in the picking robot, further enriching a status perception mode for the picking robot.

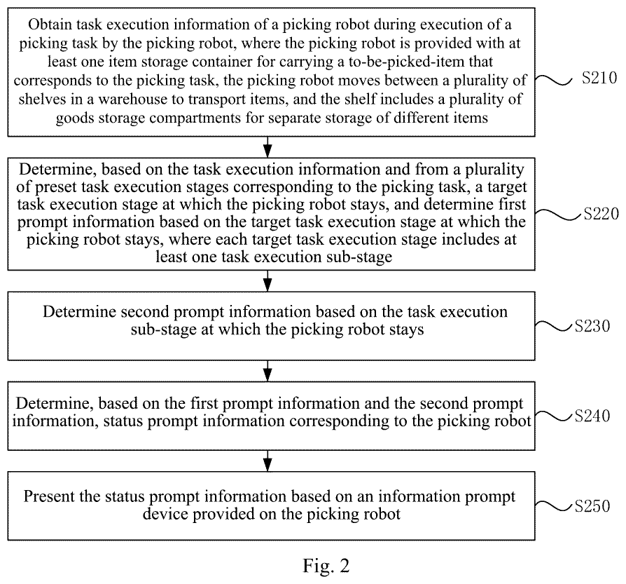

FIG. 2 is a schematic flowchart of another status prompt method according to an embodiment of the present disclosure. On the basis of the above embodiments, the technical solution of this embodiment further refines the mode of generating the status prompt information corresponding to each target task execution stage. Optionally, the determining, based on the target task execution stage, status prompt information corresponding to the picking robot includes: determining first prompt information based on the target task execution stage at which the picking robot stays, where each target task execution stage includes at least one task execution sub-stage; determining second prompt information based on the task execution sub-stage at which the picking robot stays; and determining, based on the first prompt information and the second prompt information, the status prompt information corresponding to the picking robot. For a specific implementation, reference may be made to the description of this embodiment. Details about technical features that are the same as or similar to those in the foregoing embodiment are not repeated herein.

As shown in FIG. 2, the method in this embodiment may specifically include the following steps.

S210: Obtain task execution information of a picking robot during execution of a picking task by the picking robot, where the picking robot is provided with at least one item storage container for carrying a to-be-picked-item that corresponds to the picking task, the picking robot moves between a plurality of shelves in a warehouse to transport items, and the shelf includes a plurality of goods storage compartments for separate storage of different items.

S220. Determine, based on the task execution information and from a plurality of preset task execution stages corresponding to the picking task, a target task execution stage at which the picking robot stays, and determine first prompt information based on the target task execution stage at which the picking robot stays, where each target task execution stage includes at least one task execution sub-stage.

In this embodiment of the present disclosure, the first prompt information may be understood as prompt information used to distinguish different target task execution stages at which the picking robot stays. In other words, the first prompt information is used to indicate the target task execution stage at which the picking robot stays. Exemplarily, when the target task execution stage is a picking stage, the task execution sub-stage may include, but is not limited to, at least one of the sub-stages of going to an Nth picking point, multi-machine waiting (a plurality of picking robots waiting for passage), reaching a picking point, delivery to a compartment, delivery completion, abnormality skipping, inputting an item identifier, etc. When the target task execution stage is an item review stage, the task execution sub-stage may include, but is not limited to, at least one of the sub-stages of picking task completed, going to a packing station, multi-machine waiting, scanning a container code, and confirming takeoff of a container.

Specifically, the first prompt information may include a first presentation restriction parameter for restricting an information presentation mode of the status display information. Further, the determining first prompt information based on the target task execution stage at which the picking robot stays includes: obtaining a preset first presentation restriction parameter corresponding to the target task execution stage, and generating the first prompt information based on the first presentation restriction parameter. With this technical solution, the generation mode of status prompt information for different target task execution stages can be standardized through the first presentation restriction parameter, to determine, through the information presentation restriction parameter, the target task execution stage at which the picking robot stays.

Exemplarily, the information presentation restriction parameter corresponding to the target task execution stage may include a display color restriction parameter. Such a setting has an advantage of enhancing the intuitiveness and visual sensitivity in an information display dimension by changing colors.

S230: Determine second prompt information based on the task execution sub-stage at which the picking robot stays.

It may be understood that the task execution sub-stage is a sub-stage that is obtained after subdivision of the target task execution stage. That is, the task execution sub-stage is a sub-stage that is obtained by further dividing the target task execution stage. The second prompt information may be understood as prompt information used to distinguish which task execution sub-stage of the target task execution stage at which the picking robot stays. In other words, the second prompt information is used to indicate the task execution sub-stage at which the picking robot stays.

Similarly, the second prompt information may include a second presentation restriction parameter for restricting an information presentation mode of the status display information. Further, the determining second prompt information based on the task execution sub-stage at which the picking robot stays includes: obtaining a preset second presentation restriction parameter corresponding to the target task execution stage, and generating the first prompt information based on the second presentation restriction parameter. With this technical solution, the generation mode of status prompt information for different target task execution stages can be standardized through the second presentation restriction parameter, to determine, through the information presentation restriction parameter, the task execution sub-stage at which the picking robot stays.

Exemplarily, when the first prompt information may be the display color restriction parameter, the second prompt information may specifically be a display form restriction parameter corresponding to the display color. The second prompt information may also be sound prompt information corresponding to the status prompt information. For example, the second prompt information may specifically be a preset target sound effect corresponding to the status prompt information.

Considering that the main purpose of the picking robot presenting the status prompt information is to interact with a related person (such as the picker or a manager of the picking robot), the task execution sub-stage may be classified according to the degree of human intervention corresponding to the task execution sub-stage. Then, status prompt information is generated, for different types of task execution sub-stages, by using different information presentation restriction parameters.

Specifically, the determining second prompt information based on the task execution sub-stage at which the picking robot stays may include: determining the task execution sub-stage at which the picking robot stays, determining a task operation type corresponding to the task execution sub-stage, and determining the second prompt information based on the task operation type, where the task operation type is used to indicate whether the picking robot requires manual cooperation to perform a task-related operation. In this embodiment of the present disclosure, the task operation type corresponding to the task execution sub-stage may be preset according to actual needs. In other words, the task operation type corresponding to the task execution sub-stage may be determined according to a preset correspondence between the task execution sub-stage and the task operation type.

With this technical solution, the status prompt information can be distinguished and displayed from the dimension of human-computer interaction, which allows timely discovery and thus timely response when the picking robot requires human cooperation to perform the task-related operation, and avoids excessive intervention in the picking robot when no human cooperation is required to perform the task-related operation,, thereby improving human-computer interaction experience and then effectively ensuring the task execution efficiency of the picking robot.

In order to further improve the human-computer interaction efficiency, optionally, the determining the second prompt information based on the task operation type includes: when the task operation type is used to indicate that the picking robot requires manual cooperation to perform the task-related operation, generating, as the second prompt information, operation prompt information corresponding to the task-related operation to be performed. The task-related operation may be understood as a manual operation associated with completion of a task by the picking robot. For example, the task-related operation may include, but is not limited to, at least one of an operation of manually picking goods and placing the goods into a goods placement container of the picking robot, taking the goods placement container off the picking robot for an item review operation and/or an item packaging operation, an operation of replenishing the goods placement container for the picking robot, and other operations.

With this technical solution, when the picking robot requires manual cooperation to perform the task-related operation, a related person may be prompted of the task-related operation to be performed, so that the related person quickly assist, according to the second prompt information, the picking robot in completing the task, which reduces the possibility of misoperation and avoids unnecessary human-computer interaction, thereby improving task execution efficiency.

S240: Determine, based on the first prompt information and the second prompt information, status prompt information corresponding to the picking robot.

Specifically, the status prompt information corresponding to the picking robot may be generated based on the first presentation restriction parameter and the second presentation restriction parameter.

In this embodiment of the present disclosure, the status prompt information generated based on the first prompt information and the second prompt information may allow information prompts for different levels at which the picking robot is located, which facilitates a related person in quickly locating the picking robot concerned, and further determining a mode of interaction with the picking robot, thereby providing more diversified status prompt information for human-computer interaction.

S250: Present the status prompt information based on an information prompt device provided on the picking robot.

In the technical solution of this embodiment of the present disclosure, the first prompt information is determined based on the target task execution stage at which the picking robot stays, where each target task execution stage includes the at least one task execution sub-stage, the different target task execution stages at which the picking robot stays can be intuitively distinguished based on the first prompt information. Then, the second prompt information is determined based on the task execution sub-stage at which the picking robot stays, such that which specific task execution sub-stage of the target task execution stage at which the picking robot stays can further be distinguished based on the second prompt information. Finally, the status prompt information corresponding to the picking robot is determined based on the first prompt information and the second prompt information, which enriches the task execution information of the picking robot that is obtained from the status prompt information, supports multi-level status prompts, and facilitates the picker in intuitively learning the mode of interaction with the picking robot.

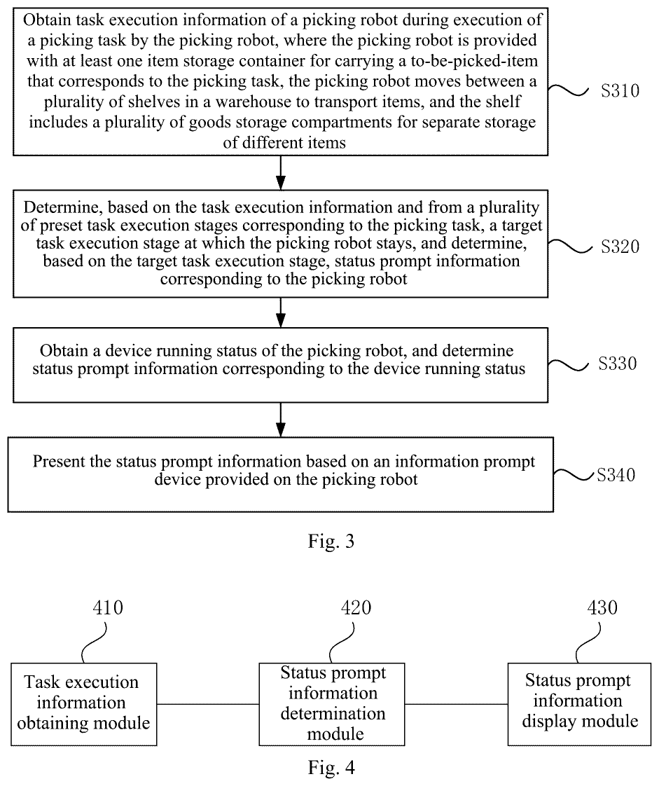

FIG. 3 is a schematic flowchart of another status prompt method according to an embodiment of the present disclosure. On the basis of the above embodiments, the technical solution of this embodiment adds a prompt for a device running status to ensure normal running of the picking robot. Optionally, the status prompt method further includes: obtaining a device running status of the picking robot, and determining status prompt information corresponding to the device running status. For a specific implementation, reference may be made to the description of this embodiment. Details about technical features that are the same as or similar to those in the foregoing embodiment are not repeated herein.

As shown in FIG. 3, the method in this embodiment may specifically include the following steps.

S310: Obtain task execution information of a picking robot during execution of a picking task by the picking robot, where the picking robot is provided with at least one item storage container for carrying a to-be-picked-item that corresponds to the picking task, the picking robot moves between a plurality of shelves in a warehouse to transport items, and the shelf includes a plurality of goods storage compartments for separate storage of different items.

S320: Determine, based on the task execution information and from a plurality of preset task execution stages corresponding to the picking task, a target task execution stage at which the picking robot stays, and determine, based on the target task execution stage, status prompt information corresponding to the picking robot.

S330: Obtain a device running status of the picking robot, and determine status prompt information corresponding to the device running status.

The device running status may be understood as a status associated with running of software and/or hardware configured in the picking robot. Exemplarily, the device running status includes at least one of a device alarm state, a device sleep state, a device charging state, and a cloud offline state. Further, the cloud offline state includes a device unconnected state and/or a device upgrade state, etc.

Optionally, the obtaining a device running status of the picking robot may specifically include: obtaining device running data of the picking robot based on a preset running parameter; and determining the device running status of the picking robot according to a pre-established association relationship among the preset running parameter, the device running data, and the device running status. The obtaining device running data of the picking robot based on a preset running parameter may be specifically acquiring the device running data of the picking robot based on a data acquisition device that is configured in the picking robot and corresponds to the preset running parameter. Exemplarily, the data acquisition device may be a sensor, data monitoring software, etc.

In this embodiment of the present disclosure, different status prompt information may also be generated for different device running data in the same running state. Optionally, the determining status prompt information corresponding to the device running status includes: determining third prompt information based on the device running status, determining fourth prompt information based on the device running data, and determining, based on the third prompt information and the fourth prompt information, the status prompt information corresponding to the device running status. Similarly, the third prompt information may be a display color, and the fourth prompt information may be a display form corresponding to the display color. The display form includes at least one of a display shape, a display size, a display position, a display frequency, and a display time.

Optionally, the determining status prompt information corresponding to the device running status includes: when the device running status includes the device alarm state, determining a device alarm type corresponding to the picking robot; and determining, based on the device alarm type, the status prompt information corresponding to the device running status.

The device alarm types include a serious failure and a temporary fault. Specifically, the serious failure may be understood as a failure that requires manual operation of the picking robot for troubleshooting. Exemplarily, the serious failure may include, but is not limited to, at least one of the picking robot undergoing an emergency stop in response to an emergency stop trigger operation, undergoing a preset type of fault (such as a communication failure and/or a line failure), having a blocked walking path, having failed navigation, etc. The temporary fault may be understood as a temporal fault that requires no manual operation of the picking robot. Exemplarily, the temporary fault may be understood as including a failure or task flow fault that the picking robot may fix by itself. The task flow fault may specifically be at least one of a temporary obstacle (such as a cart, a box, a picker, or other picking robots) in a warehouse lane that blocks the way of the picking robot, a walking path update, a device self-restart, etc. The lane may be understood as a road in the warehouse that is located between the shelves for passage of the picking robot.

With this technical solution, for different device alarm types, different status prompt information is used for prompting, such that the user intuitively identifies an alarm type that the picking robot is in, and then makes a timely response matching the device alarm type. This cannot only enable timely discovery and timely handling when the picking robot has a serious failure, but can also reduce unnecessary interference with the picking robot, thereby ensuring smooth running of the picking robot and then improving the task execution efficiency of the picking robot.

As an optional technical solution of this embodiment of the present disclosure, when the device alarm type includes the serious failure, the status prompt information may be light prompt information in a third color (e.g., red); or when the device alarm type includes the temporary fault, the status prompt information may be light prompt information in a fourth color (e.g., yellow). Further, for a specific failure type of the serious failure, the status prompt information may also be displayed in a different display form in the third color, and/or for a specific fault type of the temporary fault, the status prompt information may also be displayed in a different display form in the fourth color.

Status prompt information corresponding to different device running states may have different information presentation modes. For example, the status prompt information corresponding to the different device running states may have different display colors. More specifically, the status prompt information corresponding to the different device running states may correspond to light of different display colors. Further, at least part of the status prompt information corresponding to the device running status may include voice prompt information. For example, when the picking robot is in the cloud offline state, the status prompt information may be displayed in a fifth color (e.g., white).

S340: Present the status prompt information based on an information prompt device provided on the picking robot.

In the technical solution of this embodiment of the present disclosure, the device running status of the picking robot is obtained, which enables inspection of the picking robot from the perspective of software and hardware configurations of the device itself, thereby reducing the impact of running issues of the device itself on task execution. Then, the status prompt information corresponding to the device running status is determined and then presented, which allows a related person such as the picker or device manager to quickly and intuitively learn the device running status of the picking robot, to make correct responses to the device running status of the picking robot, thereby increasing information prompt dimensions of the picking robot.

FIG. 4 is a schematic diagram of a structure of a status prompt apparatus according to an embodiment of the present disclosure. As shown in FIG. 4, the status prompt apparatus includes a task execution information obtaining module 410, a status prompt information determination module 420, and a status prompt information display module 430. The task execution information obtaining module 410 is configured to obtain task execution information of a picking robot during execution of a picking task by the picking robot, where the picking robot is provided with at least one item storage container for carrying a to-be-picked-item that corresponds to the picking task, the picking robot moves between a plurality of shelves in a warehouse to transport items, and the shelf includes a plurality of goods storage compartments for separate storage of different items. The status prompt information determination module 420 is configured to determine, based on the task execution information and from a plurality of preset task execution stages corresponding to the picking task, a target task execution stage at which the picking robot stays, and determine, based on the target task execution stage, status prompt information corresponding to the picking robot. The status prompt information display module 430 is configured to present the status prompt information based on an information prompt device provided on the picking robot.

In the technical solution of this embodiment of the present disclosure, first, through the task execution information obtaining module 410, the task execution information of the picking robot is obtained, and the target task execution stage at which the picking robot stays is determined based on the task execution information, so that the target task execution stage at which the picking robot stays when the picking robot moves between the plurality of shelves in the warehouse to transport items can be accurately determined, to implement refined division of the target task execution stage at which the picking robot stays. Then, the status prompt information corresponding to the picking robot is determined by the status prompt information determination module 420 based on the target task execution stage, so that status prompt information corresponding to different target task execution stages can be determined separately, to provide distinguished prompts for the different target task execution stages. Finally, the status prompt information is presented by the status prompt information display module 430 based on the information prompt device provided on the picking robot, where by providing the information prompt device on the picking robot, it is convenient for a user to quickly locate the picking robot that generates the status prompt information, and the status prompt information displayed on the picking robot allows a picker to learn the target task execution stage at which the picking robot stays in a timely, convenient, and intuitive manner. Thus, the technical problems of relatively limited interactive information available from picking robots and low efficiency in executing picking tasks are solved, the experience of the picker during information interaction with the picking robot is enhanced, and the task execution efficiency of the picking robot is improved.

On the basis of any one of the optional technical solutions of the above embodiments of the present disclosure, optionally, the status prompt information determination module 420 includes a first prompt information determination unit, a second prompt information determination unit, and a status prompt information determination unit. The first prompt information determination unit is configured to determine first prompt information based on the target task execution stage at which the picking robot stays, where each target task execution stage includes at least one task execution sub-stage. The second prompt information determination unit is configured to determine second prompt information based on the task execution sub-stage at which the picking robot stays. The status prompt information determination unit is configured to determine, based on the first prompt information and the second prompt information, the status prompt information corresponding to the picking robot.

On the basis of any one of the optional technical solutions of the above embodiments of the present disclosure, optionally, the second prompt information determination unit may be specifically configured to: determine the task execution sub-stage at which the picking robot stays, determine a task operation type corresponding to the task execution sub-stage, and determine the second prompt information based on the task operation type, where the task operation type is used to indicate whether the picking robot requires manual cooperation to perform a task-related operation.

On the basis of any one of the optional technical solutions of the above embodiments of the present disclosure, optionally, the second prompt information determination unit may be further configured to: when the task operation type is used to indicate that the picking robot requires manual cooperation to perform the task-related operation, generate, as the second prompt information, operation prompt information corresponding to the task-related operation to be performed.

On the basis of any one of the optional technical solutions of the above embodiments of the present disclosure, optionally, the status prompt apparatus further includes a device running status determination module. The device running status determination module is configured to obtain a device running status of the picking robot, and determine status prompt information corresponding to the device running status, where the device running status includes at least one of a device alarm state, a device sleep state, a device charging state, and a cloud offline state, and the cloud offline state includes a device unconnected state and/or a device upgrade state.

On the basis of any one of the optional technical solutions of the above embodiments of the present disclosure, optionally, the device running status determination module includes an alarm type determination unit and a device alarm prompt unit. The alarm type determination unit is configured to, when the device running status includes the device alarm state, determine a device alarm type corresponding to the picking robot, where the device alarm type includes a serious failure and a temporary fault. The device alarm prompt unit is configured to determine, based on the device alarm type, the status prompt information corresponding to the device running status.

On the basis of any one of the optional technical solutions of the above embodiments of the present disclosure, optionally, the information prompt device includes at least one of a sound playback device, an indicator light, and an information display device. Further, the status prompt information display module 430 is configured to perform at least one of the following operations:
playing, based on the sound playback device provided on the picking robot, a target sound effect corresponding to the status prompt information;
determining, based on the status prompt information, light information of the indicator light provided on the picking robot, and controlling the indicator light to present the light information; and
displaying the status prompt information in a preset information display form based on the information display device provided on the picking robot, where the information display form includes at least one of graphics, text, an animation, and a video.

On the basis of any one of the optional technical solutions of the above embodiments of the present disclosure, optionally, the status prompt apparatus further includes a movement guidance presentation module. The mobile guidance presentation module may be specifically configured to perform detection of an associated robot based on the picking robot, generate, based on a detection result, movement guidance information corresponding to a picker, and present the movement guidance information, where the associated robot is a picking robot that is closest to the picking robot and whose distance from the picking robot is within a preset distance range.

On the basis of any one of the optional technical solutions of the above embodiments of the present disclosure, optionally, the movement guidance information includes first guidance information and second guidance information. Further, the movement guidance presentation module includes a first guidance generation unit and a second guidance generation unit. The first guidance generation unit is configured to, when the associated robot corresponding to the picking robot has been detected, generate the first guidance information for prompting the picker to move to the associated robot. The second guidance generation unit is configured to, when the associated robot corresponding to the picking robot has not been detected, generate the second guidance information for prompting the picker to follow the picking robot.

On the basis of any one of the optional technical solutions of the above embodiments of the present disclosure, optionally, the status prompt apparatus further includes an abnormality determination module and abnormality reporting module. The abnormality determination module is configured to determine target abnormality information when an abnormality is detected in the picking robot, and display at least one abnormality candidate item on the picking robot based on the target abnormality information. The abnormality reporting module is configured to report, in response to an item selection operation for the abnormality candidate item, the selected abnormality candidate item to a target management terminal.

The status prompt apparatus provided in this embodiment of the present disclosure can perform the status prompt method provided in any embodiment of the present disclosure, and has corresponding functional modules and beneficial effects for performing the status prompt method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

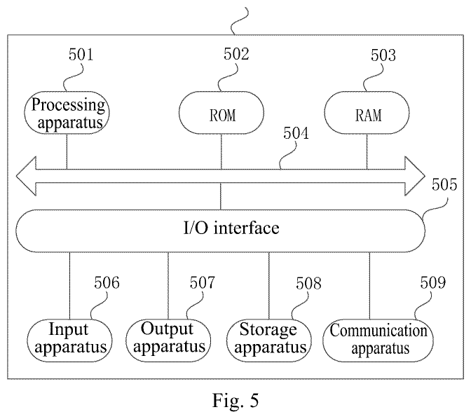

FIG. 5 is a schematic diagram of a structure of a picking robot according to an embodiment of the present disclosure. Referring to FIG. 5 below, it is a schematic diagram of a structure of a picking robot 500 suitable for implementing an embodiment of the present disclosure. The picking robot 500 may be integrated with an electronic device such as a terminal device and/or a server for executing the status prompt method. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The picking robot shown in FIG. 5 is merely an example, and shall not impose any limitation on the function and scope of use of the embodiments of the present disclosure.

As shown in FIG. 5, the picking robot 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the picking robot 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the picking robot 500 to perform wireless or wired communication with other devices to exchange data. Although FIG. 5 shows the picking robot 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The picking robot according to this embodiment of the present disclosure and the status prompt method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the status prompt method according to the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain task execution information of a picking robot during execution of a picking task by the picking robot, where the picking robot is provided with at least one item storage container for carrying a to-be-picked-item that corresponds to the picking task, the picking robot moves between a plurality of shelves in a warehouse to transport items, and the shelf includes a plurality of goods storage compartments for separate storage of different items; determine, based on the task execution information and from a plurality of preset task execution stages corresponding to the picking task, a target task execution stage at which the picking robot stays, and determine, based on the target task execution stage, status prompt information corresponding to the picking robot; and present the status prompt information based on an information prompt device provided on the picking robot.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. Instead, the specific features and actions described above are merely exemplary forms of implementing the claims.

1. A status prompt method, comprising:
obtaining task execution information of a picking robot during execution of a picking task by the picking robot, wherein the picking robot is provided with at least one item storage container for carrying a to-be-picked-item that corresponds to the picking task, the picking robot moves between a plurality of shelves in a warehouse to transport items, and the shelf comprises a plurality of goods storage compartments for separate storage of different items;
determining, based on the task execution information and from a plurality of preset task execution stages corresponding to the picking task, a target task execution stage at which the picking robot stays, and determining, based on the target task execution stage, status prompt information corresponding to the picking robot; and
presenting the status prompt information based on an information prompt device provided on the picking robot.

2. The status prompt method according to claim 1, wherein the determining, based on the target task execution stage, status prompt information corresponding to the picking robot comprises:
determining first prompt information based on the target task execution stage at which the picking robot stays, wherein each target task execution stage comprises at least one task execution sub-stage;
determining second prompt information based on the task execution sub-stage at which the picking robot stays; and
determining, based on the first prompt information and the second prompt information, the status prompt information corresponding to the picking robot.

3. The status prompt method according to claim 2, wherein the determining second prompt information based on the task execution sub-stage at which the picking robot stays comprises:
determining the task execution sub-stage at which the picking robot stays, determining a task operation type corresponding to the task execution sub-stage, and determining the second prompt information based on the task operation type, wherein the task operation type is used to indicate whether the picking robot requires manual cooperation to perform a task-related operation.

4. The status prompt method according to claim 3, wherein the determining the second prompt information based on the task operation type comprises:
when the task operation type is used to indicate that the picking robot requires manual cooperation to perform the task-related operation, generating, as the second prompt information, operation prompt information corresponding to the task-related operation to be performed.

5. The status prompt method according to claim 1, further comprising:
obtaining a device running status of the picking robot, and determining status prompt information corresponding to the device running status, wherein the device running status comprises at least one of a device alarm state, a device sleep state, a device charging state, and a cloud offline state, and the cloud offline state comprises a device unconnected state and/or a device upgrade state.

6. The status prompt method according to claim 5, wherein the determining status prompt information corresponding to the device running status comprises:
when the device running status comprises the device alarm state, determining a device alarm type corresponding to the picking robot, wherein the device alarm type comprises a serious failure and a temporary fault; and
determining, based on the device alarm type, the status prompt information corresponding to the device running status.

7. The status prompt method according to claim 1, wherein the information prompt device comprises at least one of a sound playback device, an indicator light, and an information display device; and the presenting the status prompt information based on an information prompt device provided on the picking robot comprises at least one of the following operations:
playing, based on the sound playback device provided on the picking robot, a target sound effect corresponding to the status prompt information;
determining, based on the status prompt information, light information of the indicator light provided on the picking robot, and controlling the indicator light to present the light information; and
displaying the status prompt information in a preset information display form based on the information display device provided on the picking robot, wherein the information display form comprises at least one of graphics, text, an animation, and a video.

8. The status prompt method according to claim 1, further comprising:
performing detection of an associated robot based on the picking robot, generating, based on a detection result, movement guidance information corresponding to a picker, and presenting the movement guidance information, wherein the associated robot is a picking robot that is closest to the picking robot and whose distance from the picking robot is within a preset distance range.

9. The status prompt method according to claim 8, wherein the movement guidance information comprises first guidance information and second guidance information; and the generating, based on a detection result, movement guidance information corresponding to a picker comprises:
when the associated robot corresponding to the picking robot has been detected, generating the first guidance information for prompting the picker to move to the associated robot; or
when the associated robot corresponding to the picking robot has not been detected, generating the second guidance information for prompting the picker to follow the picking robot.

10. The status prompt method according to claim 1, further comprising:
determining target abnormality information when an abnormality is detected in the picking robot, and displaying at least one abnormality candidate item on the picking robot based on the target abnormality information; and
reporting, in response to an item selection operation for the abnormality candidate item, the selected abnormality candidate item to a target management terminal.

11. A picking robot, comprising:
one or more processors; and
a storage apparatus configured to store one or more programs,
wherein the one or more programs, when executed by the one or more processors, cause the one or more processors to implement a status prompt method,
wherein the method comprises:
obtaining task execution information of a picking robot during execution of a picking task by the picking robot, wherein the picking robot is provided with at least one item storage container for carrying a to-be-picked-item that corresponds to the picking task, the picking robot moves between a plurality of shelves in a warehouse to transport items, and the shelf comprises a plurality of goods storage compartments for separate storage of different items;
determining, based on the task execution information and from a plurality of preset task execution stages corresponding to the picking task, a target task execution stage at which the picking robot stays, and determining, based on the target task execution stage, status prompt information corresponding to the picking robot; and
presenting the status prompt information based on an information prompt device provided on the picking robot.

12. The picking robot according to claim 11, wherein the one or more processors is further caused to:
determining first prompt information based on the target task execution stage at which the picking robot stays, wherein each target task execution stage comprises at least one task execution sub-stage;
determining second prompt information based on the task execution sub-stage at which the picking robot stays; and
determining, based on the first prompt information and the second prompt information, the status prompt information corresponding to the picking robot.

13. The picking robot according to claim 12, wherein the one or more processors is further caused to:
determining the task execution sub-stage at which the picking robot stays, determining a task operation type corresponding to the task execution sub-stage, and determining the second prompt information based on the task operation type, wherein the task operation type is used to indicate whether the picking robot requires manual cooperation to perform a task-related operation.

14. The picking robot according to claim 13, wherein the one or more processors is further caused to:
when the task operation type is used to indicate that the picking robot requires manual cooperation to perform the task-related operation, generating, as the second prompt information, operation prompt information corresponding to the task-related operation to be performed.

15. The picking robot according to claim 11, wherein the one or more processors is further caused to:
obtaining a device running status of the picking robot, and determining status prompt information corresponding to the device running status, wherein the device running status comprises at least one of a device alarm state, a device sleep state, a device charging state, and a cloud offline state, and the cloud offline state comprises a device unconnected state and/or a device upgrade state.

16. The picking robot according to claim 15, wherein the one or more processors is further caused to:
when the device running status comprises the device alarm state, determining a device alarm type corresponding to the picking robot, wherein the device alarm type comprises a serious failure and a temporary fault; and
determining, based on the device alarm type, the status prompt information corresponding to the device running status.

17. The picking robot according to claim 11, wherein the information prompt device comprises at least one of a sound playback device, an indicator light, and an information display device; and the presenting the status prompt information based on an information prompt device provided on the picking robot comprises at least one of the following operations:
playing, based on the sound playback device provided on the picking robot, a target sound effect corresponding to the status prompt information;
determining, based on the status prompt information, light information of the indicator light provided on the picking robot, and controlling the indicator light to present the light information; and
displaying the status prompt information in a preset information display form based on the information display device provided on the picking robot, wherein the information display form comprises at least one of graphics, text, an animation, and a video.

18. The picking robot according to claim 11, wherein the one or more processors is further caused to:
performing detection of an associated robot based on the picking robot, generating, based on a detection result, movement guidance information corresponding to a picker, and presenting the movement guidance information, wherein the associated robot is a picking robot that is closest to the picking robot and whose distance from the picking robot is within a preset distance range.

19. The picking robot according to claim 11, wherein the one or more processors is further caused to:
determining target abnormality information when an abnormality is detected in the picking robot, and displaying at least one abnormality candidate item on the picking robot based on the target abnormality information; and
reporting, in response to an item selection operation for the abnormality candidate item, the selected abnormality candidate item to a target management terminal.

20. A storage medium comprising computer-executable instructions, wherein the computer-executable instructions, when executed by a computer processor, are used to perform a status prompt method,
wherein the method comprises:
obtaining task execution information of a picking robot during execution of a picking task by the picking robot, wherein the picking robot is provided with at least one item storage container for carrying a to-be-picked-item that corresponds to the picking task, the picking robot moves between a plurality of shelves in a warehouse to transport items, and the shelf comprises a plurality of goods storage compartments for separate storage of different items;
determining, based on the task execution information and from a plurality of preset task execution stages corresponding to the picking task, a target task execution stage at which the picking robot stays, and determining, based on the target task execution stage, status prompt information corresponding to the picking robot; and
presenting the status prompt information based on an information prompt device provided on the picking robot.
